(19) United States
(12) Patent Application Publication
(10) Pub. No.: US 2004/0221469 A1
(43) Pub. Date: Nov. 11, 2004

(54) AIM chaulk box/layout assistant

(76) Inventor: David Risher, Charlotte, NC (US)

Correspondence Address: Malcolm E. Whittaker, Whittaker Law Firm, Suite 606, 8 Greenway Plaza, Houston, TX, 77046-0801, US

(21) Appl. No.: 10/424,501

(22) Filed: Apr. 28, 2003

Related U.S. Application Data
(60) Provisional application No. 60/376,069, filed on Apr. 29, 2002.

(51) Int. Cl. G01B 3/10

(52) U.S. Cl. 33/760

(57) ABSTRACT

An AIM Chaulk Box including a base assembly comprising a top surface, a bottom surface and a plurality of side surfaces collectively defining an internal cavity; a radius measuring assembly attached to one of the plurality of side surfaces of the base assembly, wherein the radius measuring assembly comprises a pivot structure operable for pivotably engaging a first end of a tape-like structure; and a chaulk line tensioning assembly attached to one of the plurality of side surfaces of the base assembly, wherein the chaulk line tensioning assembly comprises a fitting operable for securely engaging a first end of a string-like structure.

### CROSS-REFERENCE TO RELATED APPLICATION

The present non-provisional patent application claims the benefit of a U.S. Provisional Patent Application filed on Apr. 29, 2002, with Ser. No. 60/376,069.

### FIELD OF THE INVENTION

The present invention relates generally to carpentry devices and related construction trade tools. More specifically, the present invention relates to a measuring tape and chaulk line holding device that may be operated by a single worker.

### BACKGROUND OF THE INVENTION

At the present time, there are a number of Chaulk Line Anchors and Chaulk Line Holders in existence. Applicant is aware of the following United States patents for Chaulk Line Anchors and/or Chaulk Line Holders:

| U.S. Patent # | | Inventor |
|---|---|---|
| | 1,567,976 | Myers |
| | 3,122,836 | Aciego |
| | 3,662,471 | Lynde |
| | 3,691,639 | Roeseler et al. |
| | 4,561,189 | Hirneise |
| | 4,813,145 | Josey, Jr. et al. |
| | 4,932,135 | Wobser, II |
| | 4,995,152 | Steckler |
| | 5,063,681 | Bradley |
| | 5,142,787 | Dadisman |
| | 5,163,230 | Gast |
| | 5,232,536 | Oshiro et al. |
| | 5,699,622 | Umbro |
| | 5,711,081 | Zaccaria |
| | 5,873,174 | Kraft |
| | 5,937,532 | Eirich et al. |
| | 6,036,133 | Milligan |
| | 6,082,014 | Beyers |
| | 6,098,299 | Collins et al. |
| | 6,138,370 | Rolfe |
| | 6,289,597 | Beyers |
| Des. | 334,717 | Evans, Jr. et al. |
| Des. | 342,686 | Rios |
| Des. | 392,197 | Reynolds |
| Des. | 434,303 | DeCosta |
| Des. | 445,045 | Olson |

Many measuring tape and chaulk line holders require two workers to operate them. Advantageously, the measuring tape and chaulk line holding device of the present invention serves as an anchor for one end of an otherwise difficult to manage measuring tape, chaulk line or the like, thereby allowing a single worker to simply and accurately complete work previously requiring two workers.

In building construction, repair work and layout/design work, accurate measurements must often be made along flat, level surfaces, as well as along curved surfaces. As such, it is often required to take accurate measurements along flat level surfaces, such as when measuring for lay-out partitions on concrete or wooden floors, or when installing flooring, carpeting or putting down chaulk line marks to establish a straight line for constructing a wall or vertical upright. After taking such measurements, it is often necessary to strike or “snap” accurate chaulk lines to provide precise guide lines for the installation of partition plates, modular flooring, wall or vertical upright construction. Typically, such measurement distances exceed the arm span of a single worker. In the past, workers have either used a makeshift method of temporarily holding one end of the tape or chaulk line, such as a nail, or having a second worker hold one end of the tape or chaulk line. Such makeshift expedients not only are not inconvenient and expensive, because of the cost of a second worker's wages, but are apt to be inaccurate as well.

Thus, what is needed is a measuring tape and chaulk line holding device that conveniently holds one end of a measuring tape and/or chaulk line. It is also desirable for a measuring tape and/or chaulk line to be quickly attached/removed, as required, and that securely and accurately holds the measuring tape and/or chaulk line in position while a measurement is being taken or a chaulk line struck by a single worker.

### BRIEF DESCRIPTION OF THE INVENTION

The present invention provides a measuring tape and chaulk line holding device that conveniently holds one end of a measuring tape and/or chaulk line to/from which the measuring tape and/or chaulk line may be quickly attached or removed, as required, and that securely and accurately holds the measuring tape and/or chaulk line in position while a measurement is being taken or a chaulk line is being struck by a single worker. Because the present invention allows one worker to accurately perform the work of two workers, it may also be referred to as an AIM Chaulk Box or Layout Assistant

In one embodiment of the present invention, the measuring tape and chaulk line holding device includes a base assembly comprising a top surface, a bottom surface and a plurality of side surfaces collectively defining an internal cavity; a radius measuring assembly attached to one of the plurality of side surfaces of the base assembly, wherein the radius measuring assembly comprises a pivot structure operable for pivotably engaging a first end of a tape-like structure; and a chaulk line tensioning assembly attached to one of the plurality of side surfaces of the base assembly, wherein the chaulk line tensioning assembly comprises a fitting operable for securely engaging a first end of a string-like structure.

In another embodiment of the present invention, the measuring tape and chaulk line holding device includes a base assembly comprising a top surface, a bottom surface and a plurality of side surfaces collectively defining an internal cavity; ballast disposed within the internal cavity defined by the top surface, the bottom surface, and the plurality of side surfaces of the base assembly; a radius measuring assembly attached to one of the plurality of side surfaces of the base assembly, wherein the radius measuring assembly comprises a pivot structure operable for pivotably engaging a first end of a tape-like structure; and a chaulk line tensioning assembly, wherein the chaulk line tensioning assembly comprises a fitting operable for securely engaging a first end of a string-like structure.

In a further embodiment of the present invention, the measuring tape and chaulk line holding device includes a base assembly comprising a top surface, a bottom surface and a plurality of side surfaces collectively defining an internal cavity; ballast disposed within the internal cavity defined by the top surface, the bottom surface, and the plurality of side surfaces of the base assembly; a radius measuring device assembly attached to one of the plurality of side surfaces of the base assembly, wherein the radius measuring device comprises a pivot structure operable for pivotably engaging a first end of a tape-like structure, and wherein the radius measuring assembly further comprises a support structure operable for attaching the pivot structure to one of the plurality of side surfaces of the base assembly; and a chaulk line tensioning assembly attached to one of the plurality of side surfaces of the base assembly, wherein the chaulk line tensioning assembly further comprises a substantially triangular planar surface operable for attaching the fitting to the one of the plurality of side surfaces of the base assembly.

### BRIEF DESCRIPTION OF THE DRAWINGS

FIG. 1 is a perspective view of one embodiment of the present invention in use.

FIG. 2 is another perspective view of the present invention.

FIG. 3 is a top plan view of the present invention.

FIG. 4 is a bottom plan view of the present invention.

FIG. 5 is a detailed side view of the radius measuring assembly of the present invention.

FIG. 6 is a cross-sectional side view of the radius measuring assembly of the present invention.

FIG. 7 is side plan view of a the present invention, highlighting the radius measuring assembly.

FIG. 8 is a detailed side view of the chaulk line tensioning assembly of the present invention.

FIG. 9 is a side plan view of the present invention, highlighting the chaulk line tensioning assembly.

FIG. 10 is a side plan view of the present invention.

FIG. 11 is another side plan view of the present invention.

FIG. 12 is a cross-sectional side view of the chaulk line tensioning assembly of the present invention in an assembled state.

FIG. 13 is a cross-sectional side view of the chaulk line tensioning assembly of the present invention in a disassembled state.

### DETAILED DESCRIPTION OF THE INVENTION

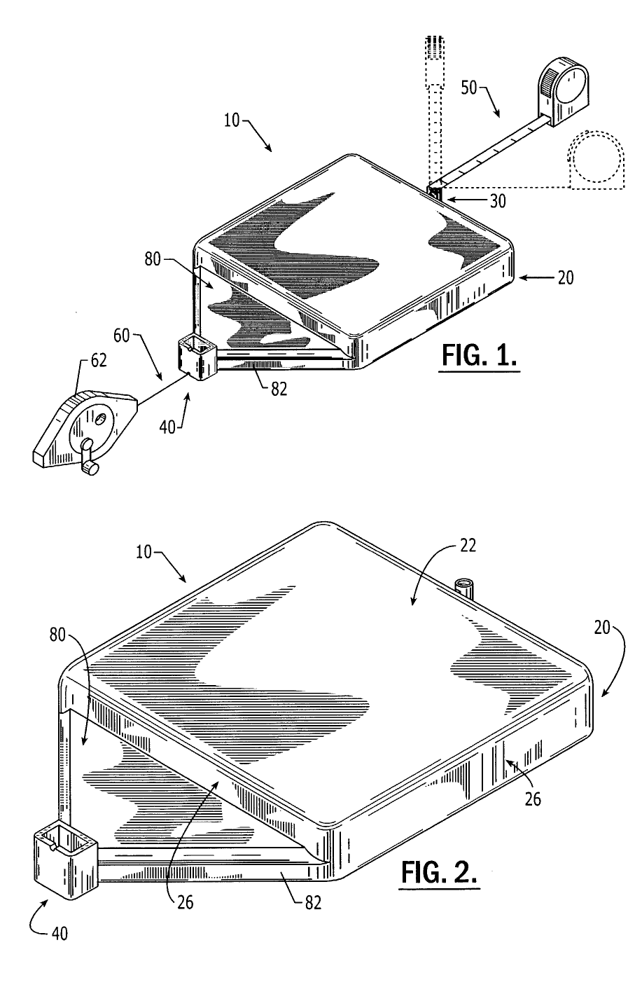

Referring now to FIG. 1, wherein like numerals designate like components or structures, it can be seen that in one embodiment of the invention that AIM Chaulk Box 10 has a base assembly 20, a radius measuring assembly 30 and a chaulk line tensioning assembly 40. The radius measuring assembly 30 is operable for securely engaging and holding one end of a measuring tape 50, string or the like used to measure a given distance or establish and mark a predetermined radius. Likewise, the chaulk line tensioning assembly 40 is operable for securely engaging and holding one end of a chaulk line 60, string or the like used to strike a chaulk line or otherwise establish a reference line.

Referring now to FIGS. 2 and 3, the base assembly 20 includes top surface 22, bottom surface 24, side surfaces 26. The top surface 22, the bottom surface 24 and the side surfaces 26 may be made of metal plastic, wood or any other suitable light, formable, substantially-rigid material. Collectively, top surface 22, sides 26 and top surface 24 define an internal cavity(not shown). Preferably, when in use, the internal cavity is partially or fully filled with ballast (not shown). Accordingly, the internal cavity is preferably sized such that a sufficient amount of ballast may be disposed within the internal cavity to raise the weight of the AIM Chaulk Box 10 to about nine pounds or greater. It has been found that the AIM Chaulk Box 10 will not move when in use if it has an overall weight of about nine pounds or greater. The ballast located in the internal cavity may include metal bars, metal grindings/filings, sand or any other suitable dense material. Any material that is sufficiently dense that it will increase the weight of AIM Chaulk Box 10 to greater than about nine pounds is suitable. Although exemplary weights and ballast materials have been described herein, these weights and ballast materials are not intended to be limiting and other suitable weights and/or ballast materials may be utilized.

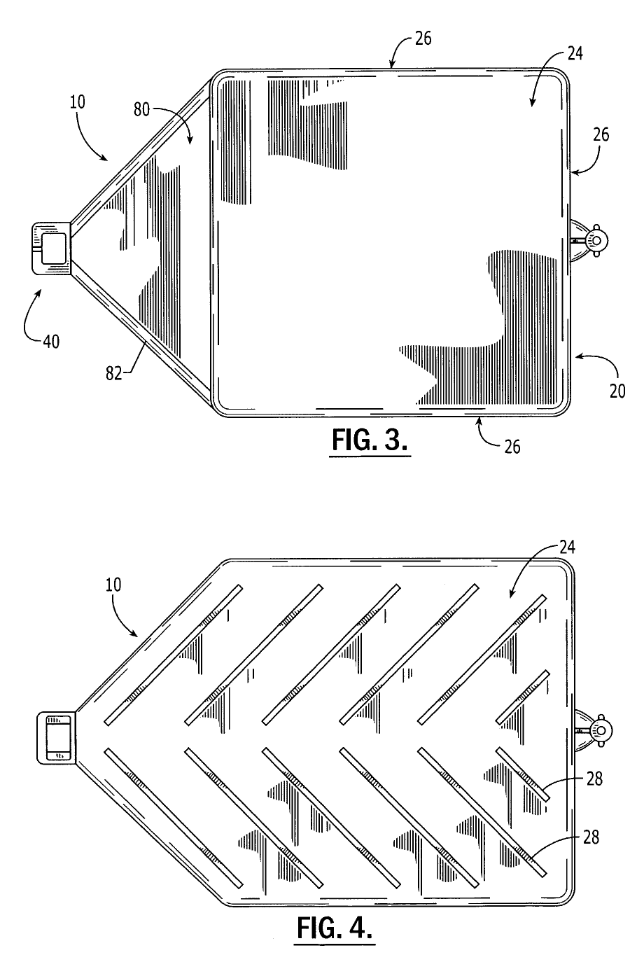

Referring to FIG. 4, bottom surface 24 may include a plurality of raised anti-slip grip structures 28. These anti-slip grip structures 28 may be integrally formed with the bottom surface 24 of AIM Chaulk Box 10. Alternatively, the plurality of anti-slip grip structures 28 may consist of a plurality of rubber or plastic strips bonded with or otherwise fixedly attached to the bottom surface 24. Anti-slip grip structures 28 may be arranged in any pattern that frictionally resists the movement of AIM Chaulk Box 10 with respect to a surface on which it is placed.

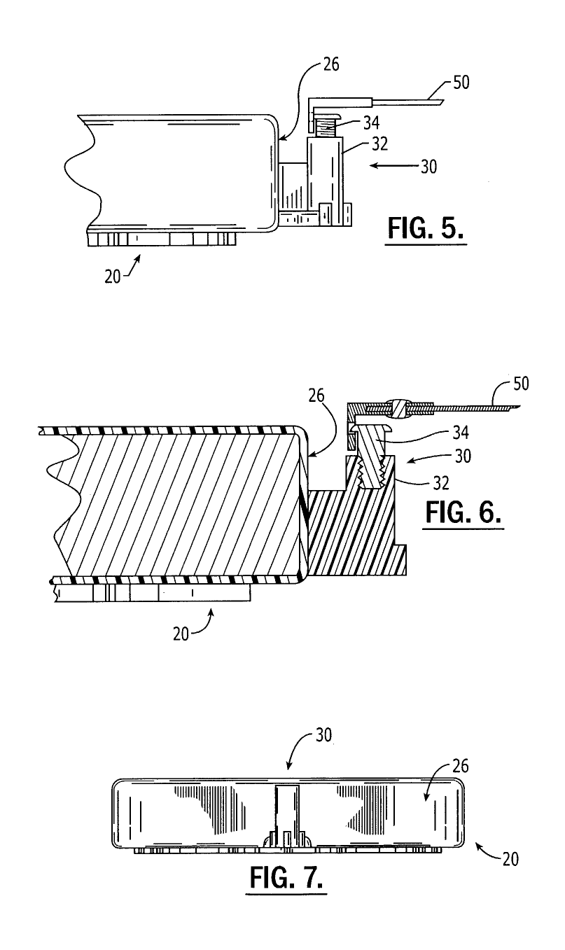

Referring to FIGS. 5, 6, and 7, radius measuring assembly 30 is integrally formed or fixedly or removably attached to base assembly 20. In operation, as seen in FIGS. 5 and 6, radius measuring assembly 30 securely holds one end of the measuring tape 50 (FIGS. 5 and 6), string or the like. Specifically, the radius measuring assembly 30 includes a support structure 32 (FIGS. 5 and 6) extending outwardly from one of the side surfaces 26 of base assembly 20. Preferably, the radius measuring assembly 30 is substantially centrally located on one of the side surfaces 26 of base assembly 20. The support structure 32 may be integrally formed with or fixedly or removably attached to side surface 26 of base assembly 20. A pivot structure 34 (FIGS. 5 and 6) is integrally formed with or fixedly or removably attached to support structure 32. For example, the pivot structure 34 may consist of a substantially-cylindrical screw that is screwed into the support structure 32. This screw may be made of metal, plastic, or any other substantially-rigid material.

In operation, one end of the measuring tape 50, string or the like pivotably engages radius measuring assembly 30. Specifically, one end of the measuring tape 50, string or the like pivotally engages the pivot structure 34. With the radius measuring assembly 30 positioned over a predetermined point selected by the worker, the measuring tape 50, string or the like may then be stretched out by the worker to take a given measurement. Alternatively, with the radius measuring assembly 30 positioned over a point selected by a worker, the measuring tape 50, string or the like may be stretched out to a predetermined length selected by the worker and a radius may be marked around the predetermined point selected by the worker.

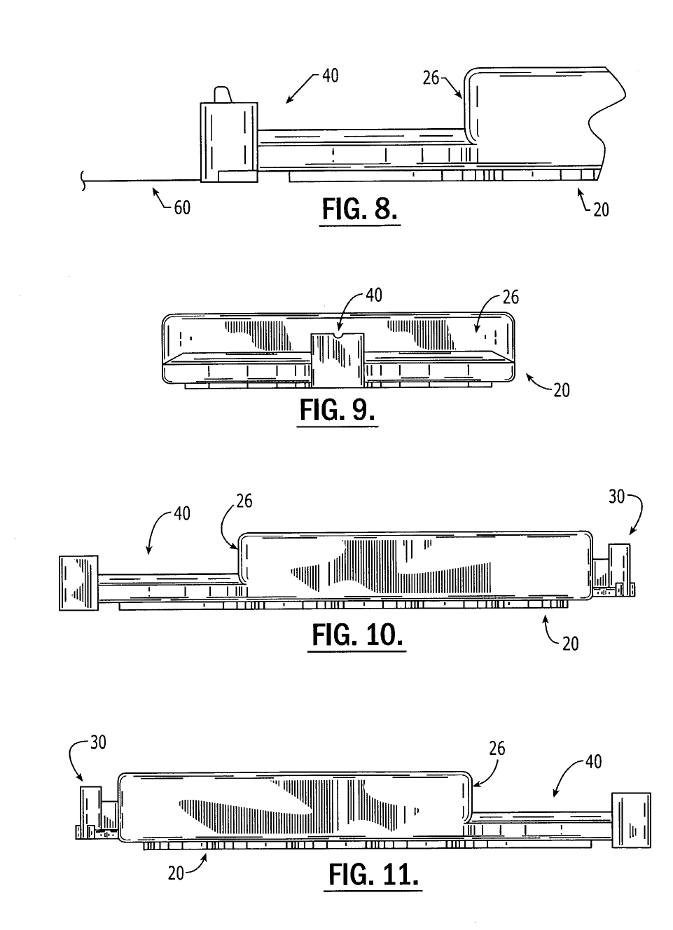

Referring now to FIGS. 8, 9, 10 and 11, the chaulk line tensioning assembly 40 is substantially centrally located on one of the side surfaces 26. Preferably, chaulk line tensioning assembly 40 is positioned on the opposite side surface 26 where radius measuring assembly 30 is positioned. (FIGS. 10 and 11). The chaulk line tensioning assembly 40 and radius measuring assembly 30 may, however, be positioned in alternative locations. The chaulk line tensioning assembly assembly 40 may be integrally formed with or fixedly or removably attached to the base assembly 20. In operation, the chaulk line tensioning assembly 40 securely holds one end of a conventional chaulk line 60 associated with a conventional chaulk line holder 62 (FIG. 1). As is known to those of ordinary skill in the art, the chaulk line 60 and chaulk line holder 62 may be used to mark the location of and/or create a frame of reference for the placement of a wall or similar linear structure. Chaulk line holder 62 includes a housing and a reel of string, line or the like that retains chaulk dust stored within the housing. The string, line or the like may be of any suitable length desired by a worker. While keeping the chaulk line 60 taught, the chaulk line tensioning assembly 40 is positioned over a pre-determined point selected by the worker, such as a point associated with the end of a wall or other linear structure. The worker then unwinds the chaulk line 60 from chaulk line holder 62 until the distal end of the wall or other linear structure is reached. The worker than “snaps” the chaulk line 60, thereby leaving a chaulk mark on the surface on which the wall or other linear structure will be positioned.

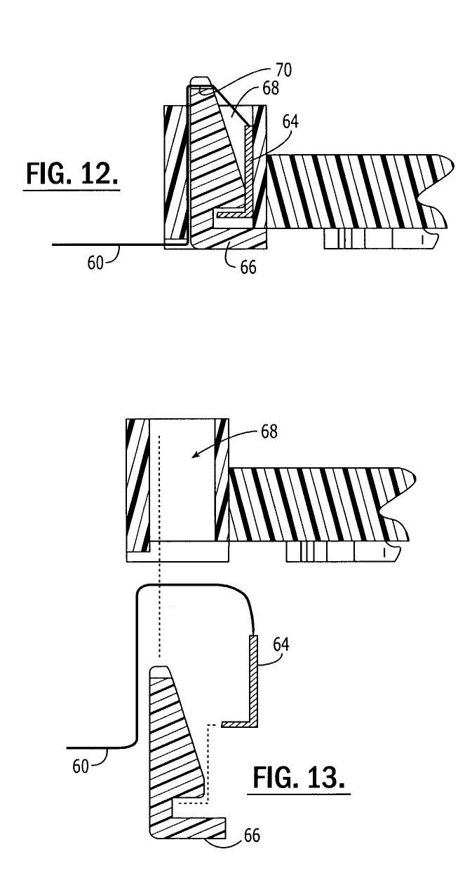

Referring to FIGS. 12 and 13, in the preferred embodiment of the present invention, an L-shaped piece 64 attached to one end of the chaulk line 60 is slidably received by a fitting 66. Fitting 66 is then slidably received by a channel 68 disposed within a portion of the chaulk line tensioning assembly 40. The chaulk line 60 is guided by a groove 70 (FIG. 12) disposed along the fitting 66. Groove 70 is preferably disposed along fitting 66 to guide chaulk line 60 so that it does not become tangled and also minimizing or preventing lateral movement of chaulk line 60.

Referring again to FIGS. 1, 2 and 3, chaulk line tensioning assembly 40 is preferably outwardly displaced from base assembly 20 by planar surface 80 and lip structure 82. For ease of manufacturing and to reduce the amount of materials required to make AIM Chaulk Box 10, planar surface 80 is preferably roughly triangular in shape. As is also well known to one skilled in the art, a conventional chaulk line holder 62 (FIG. 1) is generally triangular in shape. Thus, planar surface 80 is preferably sized slightly larger than a conventional chaulk line holder 62. Collectively, planar surface 80 and lip structure 82 allow a worker to store a conventional chaulk line holder 62, when it is not in use.

It is within the scope of the present invention that base assembly could include a cover(not shown) to allow a user to access the internal cavity of base assembly 20. This would allow a worker to increase or decrease the amount of ballast contained within the internal cavity, thereby increasing or decreasing the overall weight of the AIM Chaulk Box 10. The cover may be removably attached to base assembly 20. In this alternative embodiment, the cover would preferably be attached to base assembly 20 with threaded screws, clips or the like.

It is apparent that the present invention provides a novel AIM Chaulk Box that may be operated by a single worker. Although the AIM Chaulk Box has been shown and described with reference to preferred embodiments and examples thereof, modifications and alterations to the AIM Chaulk Box of the present invention may be apparent to those of ordinary skill in the art. All such equivalent embodiments and examples are within the spirit and scope of the present invention and are intended to be covered by the following claims.

What is claimed is:

1. An AIM Chaulk Box, comprising:
a base assembly having a top surface, a bottom surface and a plurality of side surfaces collectively defining an internal cavity;
a radius measuring assembly attached to one of the plurality of side surfaces of the body assembly, wherein the radius assembly measuring assembly comprises a pivot structure operable for pivotably engaging a first end of a tape-like structure; and,
a chaulk line tensioning assembly attached to one of the plurality of side surfaces of the base assembly, wherein the radius measuring assembly comprises a fitting operable for securely engaging a first end of a string-like structure.

2. The AIM Chaulk Box of claim 1, further comprising ballast disposed within the internal cavity defined by the top surface, the bottom surface, and the plurality of side surfaces of the base assembly.

3. The AIM Chaulk Box of claim 2, wherein the ballast has a weight of about nine pounds or greater.

4. The AIM Chaulk Box of claim 1, wherein the top surface of the base assembly comprises a removable cover that may be selectively removed from the base assembly.

5. The AIM Chaulk Box of claim 1, wherein the radius measuring assembly further comprises a support structure operable for attaching the pivot structure to the one one of the plurality of side surfaces of the base assembly.

6. The AIM Chaulk Box of claim 1, wherein the chaulk line tensioning assembly further comprises a substantially triangular planar surface operable for attaching the fitting to the one of the plurality of side surfaces of the base assembly.

7. The AIM Chaulk Box of claim 1, wherein the base assembly further comprises a plurality of raised anti-slip grip structures associated with the bottom surface of the base assembly, wherein the plurality of raised anti-slip grip structures are operable for frictionally resisting movement of the base assembly with respect to a surface on which the base assembly is placed.

8. The AIM Chaulk Box of claim 1, wherein the tape-like structure comprises a measuring tape.

9. The AIM Chaulk Box of claim 1, wherein the string-like structure comprises a chaulk line.

10. An AIM Chaulk Box, comprising:
a base assembly comprising a top surface, a bottom surface and a plurality of side surfaces collectively defining an internal cavity;
ballast disposed within the internal cavity defined by the top surface, the bottom surface, and the plurality of side surfaces of the base assembly;
a radius measuring assembly attached to one of the plurality of side surfaces of the base assembly, wherein the radius measuring assembly comprises a pivot structure operable for pivotably engaging a first end of a tape-like structure; and,
a chaulk line tensioning assembly attached to one of the plurality of side surfaces of the base assembly, wherein the chaulk line tensioning assembly comprises a fitting operable for securely engaging a first end of a string-like structure.

11. The AIM Chaulk Box of claim 10, wherein the ballast has a weight of about nine pounds or greater.

12. The AIM Chaulk Box of claim 10, wherein the top surface of the base assembly comprises a removable cover that may be selectively removed from the base assembly.

13. The AIM Chaulk Box of claim 10, wherein the radius measuring assembly further comprises a support structure operable for attaching the pivot structure to the one one of the plurality of side surfaces of the base assembly.

14. The AIM Chaulk Box of claim 10, wherein the chaulk line tensioning assembly further comprises a substantially triangular planar surface operable for attaching the fitting to the one of the plurality of side surfaces of the base assembly.

15. The AIM Chaulk Box of claim 10, wherein the base assembly further comprises a plurality of raised anti-slip grip structures associated with the bottom surface of the base assembly, wherein the plurality of raised anti-slip grip structures are operable for frictionally resisting movement of the base assembly with respect to a surface on which the base assembly is placed.

16. The AIM Chaulk Box of claim 10, wherein the tape-like structure comprises a measuring tape.

17. The AIM Chaulk Box of claim 10, wherein the string-like structure comprises a chaulk line.

18. An AIM Chaulk Box, comprising:
a base assembly comprising a top surface, a bottom surface and a plurality of side surfaces collectively defining an internal cavity;
ballast disposed within the internal cavity defined by the top surface, the bottom surface, and the plurality of side surfaces of the base assembly;
a radius measuring assembly attached to one of the plurality of side surfaces of the base assembly, wherein the radius measuring assembly comprises a pivot structure operable for pivotably engaging a first end of a tape-like structure, and wherein the radius measuring assembly further comprises a support structure operable for attaching the pivot structure to the one of the plurality of side surfaces of the base assembly; and,
a chaulk line tensioning assembly attached one of the plurality of side surfaces of the base assembly, wherein the chaulk line tensioning assembly comprises a fitting operable for securely engaging a first end of a string-like structure, and wherein the chaulk line tensioning assembly further comprises a substantially triangular planar surface operable for attaching the fitting to the one of the plurality of side surfaces of the base assembly.

19. The AIM Chaulk Box of claim 18, wherein the ballast has a weight of about nine pounds or greater.

20. The AIM Chaulk Box of claim 18, wherein the top surface of the base assembly comprises a removable cover that may be selectively removed from the base assembly.

21. The AIM Chaulk Box of claim 18, further comprising a chaulk line holder associated with a second end of the string-like structure, wherein the chaulk line holder is configured such that it may be fittingly disposed on top of the substantially triangular planar surface.

22. The AIM Chaulk Box of claim 18, wherein the base assembly further comprises a plurality of raised anti-slip grip structures associated with the bottom surface of the base assembly, wherein the plurality of raised anti-slip grip structures are operable for frictionally resisting movement of the base assembly with respect to a surface on which the base assembly is placed.

23. The AIM Chaulk Box of claim 18, wherein the tape-like structure comprises a measuring tape.

24. The AIM Chaulk Box of claim 18, wherein the string-like structure comprises a chaulk line.
